(19) United States
(12) Patent Application Publication
(10) Pub. No.: US 2025/0154321 A1
(43) Pub. Date: May 15, 2025

(54) Continuous method for preparing polyamide by polycondensation

(71) Applicant: ARKEMA FRANCE, COLOMBES (FR)

(72) Inventors: Thierry BRIFFAUD, Serquigny (FR); Benjamin SAILLARD, Serquigny (FR); Célia PAILLARES, Serquigny (FR)

(73) Assignee: ARKEMA FRANCE, COLOMBES (FR)

(21) Appl. No.: 18/719,926

(22) PCT Filed: Dec. 14, 2022
(86) PCT No.: PCT/FR2022/052352

§ 371 Date: Jun. 14, 2024

(30) Foreign Application Priority Data
Dec. 15, 2021 (FR) FR2113593

(51) Int. Cl. C08G 69/10; B01J 19/06; B01J 19/20; C08G 69/04; C08G 69/36

(52) U.S. Cl. CPC C08G 69/10; B01J 19/06; B01J 19/20; C08G 69/04; C08G 69/36

(57) ABSTRACT

The invention relates to a continuous method for preparing polyamide by condensation, the method comprising the following consecutive steps: a) melting a mixture comprising polyamide monomers in an extruder or co-kneader, the monomers being delivered to the extruder or co-kneader without any water being added; and b) carrying out the polycondensation reaction of the mixture obtained at the end of step a) in a horizontal mixer-reactor, steps a) and b) of the method being carried out at a pressure close to atmospheric pressure.

The present disclosure relates to a continuous method for preparing polyamide by polycondensation.

Polyamides are most often prepared by polycondensation of a diamine and a diacid. These polycondensation reactions are generally performed in a reactor using a continuous or batch process.

In general, at the first step, a salt is formed from dicarboxylic acid and diamine monomers. This salt, optionally in an aqueous solution, is placed in a reactor and heated under pressure until a mixture of sufficient viscosity is obtained. The water initially added and the water formed throughout the polycondensation reaction is fully or partially removed from the reactor at this step. The viscosity of the mixture on leaving the reactor is generally insufficient which means that additional steps are required to increase the degree of polymerization and obtain polyamides intended in particular to be extruded. This latter step is a heat treatment step often called post-condensation. It can be performed in a continuous or batch reactor in the molten or solid state, optionally under reduced pressure.

These processes not only require relatively long reaction times (in the region of several hours), but also multiple transfers of material between different reactors at the different steps of the method: synthesis of the salt, polycondensation in the reactor, and post-condensation.

If the post-condensation step is formed in the solid state, the homogeneity of the molar masses obtained is poor as is the stability thereof. Finally, under these conditions, the reaction times are very lengthy leading to high energy costs and hence to high production costs.

The feeding of monomers in the form of a saline aqueous solution is routinely used, in particular to control stoichiometry. However, this solution is economically disadvantageous since it requires the devolatilising of large quantities of water to obtain sufficient viscosity at the end of the polycondensation step, and hence a great amount of energy and large-size equipment.

Different alternatives intended to improve these processes have been described in the literature.

Several of these comprise a step to prepare a prepolymer in a reactor, generally with a batch process, followed by a post-condensation step in an extruder under reduced pressure, to increase the molar mass of the polyamide. While they allow optimisation of the post-condensation step, these processes remain lengthy and costly since they necessitate material transfers and handling operations difficult to implement on industrial scale. In addition, isolating prepolymers comprising chain ends close to iso-stoichiometry, with viscosities and chain end contents that are stable at each batch, is industrially difficult to achieve. Often, the solution to this difficulty entails the use of diacid- or diamine-terminated prepolymers, which necessitates the feeding of large quantities of fluid monomers into the extruder, causing mixing difficulties in the extruder and major losses of monomers, in particular if the operation is conducted under reduced pressure. Said method is particularly described in application EP 0 410 649.

With a single condensation step in an extruder, by directly feeding the monomers into the input of the extruder, the molar masses obtained remain limited and often below those needed to transform the product under good conditions, in particular via extrusion, on account of the short residence times in this type of equipment (typically less than 5 minutes). Said method is particularly described in application EP 0 410 650 where the maximum inherent viscosity in solution obtained is 0.35 dL/g, which corresponds to a Mn value of only 4400 g/mol.

Application EP 2 877 516 proposes performing all the reaction and polycondensation steps from polyamide monomers in one same extruder comprising at least two feed screws in co-rotation. This requires the use of at least 2 devolatilisation zones of condensation water, making management of monomer losses difficult whether in terms of quantity or variability. In addition, the low viscosity of the product at the start of extruder complicates the management of conveying material to the first devolatilisation zone. Also, to reach residence times allowing the obtaining of a product with high viscosity, it is necessary either to use twin-screw extruders of large size (L/D≥50) or multi-screw extruders that are complicated to maintain which, in both cases, leads to a costly method difficult to implement on industrial scale. Finally, the heating efficacy provided by the barrels of extruders is low, whereas devolatilising of water requires large amounts of energy, since such equipment is designed to provide the product with most required energy via dissipated mechanical energy, but such energy is of low level in extruders used to carry out all the steps of reaction and polycondensation on account of the low mean viscosity of the product within the equipment.

It is the objective of the present disclosure to propose a method for preparing a polyamide, that is simple to implement, less costly in terms of production energy and with shorter cycle times.

### BRIEF DESCRIPTION OF THE INVENTION

The subject of the present invention is therefore a continuous method for preparing polyamide by condensation comprising the following consecutive steps: a) melting a mixture comprising polyamide monomers in an extruder or co-kneader, said monomers being delivered to the extruder or co-kneader without the addition of any water; and

(b) carrying out the polycondensation reaction of the mixture obtained after step a) in a horizontal mixer-reactor, the method being carried out at a pressure close to atmospheric pressure.

By “pressure close to atmospheric pressure” it is meant pressure lying between atmospheric pressure and atmospheric pressure+100 mbar, advantageously a pressure between atmospheric pressure and atmospheric pressure+50 mbar, more advantageously a pressure between atmospheric pressure and atmospheric pressure+10 mbar.

Advantageously, the monomers are added to the extruder or co-kneader without the addition of water. As a result, this makes it possible to eliminate some steps such as evaporation of the water usually added in prior art methods, and consequently to limit the heating energy needed for this evaporation, and hence the cycle time of the method. In addition, this allows a reduction in monomer losses by limiting entrainment by water vapour.

Additionally, according to another advantage, the entirety of devolatilisation takes place at step b), which contributes towards reducing the energy to be supplied to the melt extruder or co-kneader, and to limiting monomer loss.

Also, according to another advantage, this method is conducted at pressure close to atmospheric pressure, which also contributes towards reducing the energy required for production, towards limiting monomer losses at the time of devolatilisation and hence also to the limiting of production costs, compared with a method performed under reduced pressure.

Also, compared with a method under reduced pressure, this prevents degradation of the polymer via oxidation in the event of entry of air into the polycondensation reactor, and limits fouling of the reactor. The use of a method under reduced pressure requires many precautions and is therefore difficult to implement.

The fact that additional water is not supplied with the monomers, and the fact that operations are conducted at a pressure close to atmospheric pressure, advantageously allow the size of the installation to be reduced, and in particular allow the obtaining of a polyamide production rate in relation to installation outlay that is more advantageous than solutions proposed in the prior art.

Also, by conducting the polycondensation reaction in a mixer-reactor, rather than polycondensation performed in an extruder, it is possible to obtain better renewal of the liquid/gas interface and hence more efficient devolatilisation of volatile compounds such as polycondensation water.

This devolatilisation is additionally facilitated by the fact that, contrary to an extruder, the mixer-reactor has a continuous gas phase along the screw(s). In general, the proportion of mixer-reactor occupancy by the liquid phase is between 20 and 75% of the space initially available in the mixer-reactor.

Also, contrary to polycondensation conducted in an extruder as described in EP 2 877 516, the mixer-reactor provides better control over thermal input during polycondensation by limiting uncontrolled heating of the product via dissipation of mechanical mixing energy, which reduces risks of thermal degradation of the polyamide. Additionally, the mixer-reactor gives access to longer residence times, advantageously longer than 5 minutes, preferably longer than 15 minutes. As a result, this method advantageously allows better product quality to be obtained in terms of quality constancy and attainable viscosity.

The method advantageously allows polyamides to be obtained having a high molar mass without the need to perform a subsequent additional post-condensation step performed at the output from the mixer-reactor, such as post-condensation in the solid state.

Other characteristics of the method of the invention are specified below:
the polyamide prepared with the method is an aliphatic, cycloaliphatic, arylaliphatic, aromatic or semi-aromatic polyamide;
the polyamide is selected in particular from among polyamide 11, 11/B10, 11/BI/BT, B10, B12, MXD10, MXS.6,11/10T, 11/BACT/10T, BACT/10T;
PA11 is the polyamide obtained from polycondensation of 11-amino-undecanoic acid (A11).
11/B10 is a copolyamide obtained by condensation of 11-amino-undecanoic acid (A11) with bis-(3-methyl-4-aminocyclohexyl)-methane (or 3,3′-dimethyl-4,4′-diamino-dicyclohexyl-methane) also called BMACM or MACM (called B in this description) and sebacic acid (10).
11/BI/BT is a copolyamide obtained by polycondensation of 11-amino-undecanoic acid (A11), of bis-(3-methyl-4-aminocyclohexyl)-methane (or 3,3′-dimethyl-4,4′diamino-dicyclohexyl-methane) also called BMACM or MACM (called B in this description) with isophthalic acid (I) and terephthalic acid (T).
B10 is a homopolyamide obtained by polycondensation of bis-(3-methyl-4-aminocyclohexyl)-methane (or 3,3′-dimethyl-4,4′-diamino-dicyclohexyl-methane) also called BMACM or MACM (called B in this description) with sebacic acid (10).
B12 is a homopolyamide obtained by polycondensation of bis-(3-methyl-4-aminocyclohexyl)-methane (or 3,3′-dimethyl-4,4′-diamino-dicyclohexyl-methane) also called BMACM or MACM (called B in this description) with dodecanedioic acid (12).
MXD10 is a homopolyamide obtained by polycondensation of meta-xylylene diamine with sebacic acid (10).
MXD6 is a homopolyamide obtained by polycondensation of meta-xylylene diamine with adipic acid (6).
11/10T is a copolyamide obtained by polycondensation of 11-amino-undecanoic acid (A11) with decanediamine (10) and terephthalic acid (T).
BACT/10T is a copolyamide obtained by polycondensation of bis-(3-methyl-4-aminocyclohexyl)-methane (or 3,3′-dimethyl-4,4′diamino-dicyclohexyl-methane) also called BMACM or MACM (called B in this description) with decanediamine (10) and terephthalic acid (T).
11/BACT/10T is a copolyamide obtained by polycondensation of 11-amino-undecanoic acid (A11) with 1,3-bis(aminomethyl)cyclohexane (BAC), terephthalic acid (T) and decanediamine (10).
the mixture at step a) comprises additives;
the additives comprise at least one catalyst, at least one stabilizer, at least one antioxidant, at least one chain-limiting agent and at least one defoamer;
step a) is conducted in an extruder, preferably having at least two screws, more preferably two screws, in particular co-rotating;
the melting of the mixture of monomers is performed in the extruder or co-kneader by heating the mixture to an output temperature at step a) of between 160° C. and 300° C.;
the mixture obtained at step a) is fed into the mixer-reactor at step b) without prior devolatilisation;
the mixer-reactor comprises at least two shafts comprising agitating elements, preferably co-rotating;
the agitating shafts of the mixer-reactor are heated;
the polycondensation reaction at step b) is conducted at a temperature at most 50° C. higher than the solidification temperature of the polyamide, and/or more than 5° C. higher than this solidification temperature, preferably at a temperature of between 240° C. and 310° C.;
step b) is performed under flushing of an inert gas, preferably in countercurrent flow.

In another aspect, the invention also concerns a system for implementing a method of the invention, comprising an extruder or co-kneader directly connected to the input of a mixer-reactor, in particular without an intermediate devolatilisation device between the mixer-reactor and extruder or co-kneader.

### BRIEF DESCRIPTION OF THE FIGURE

FIG. 1 is a schematic of a system implementing the method of the invention.

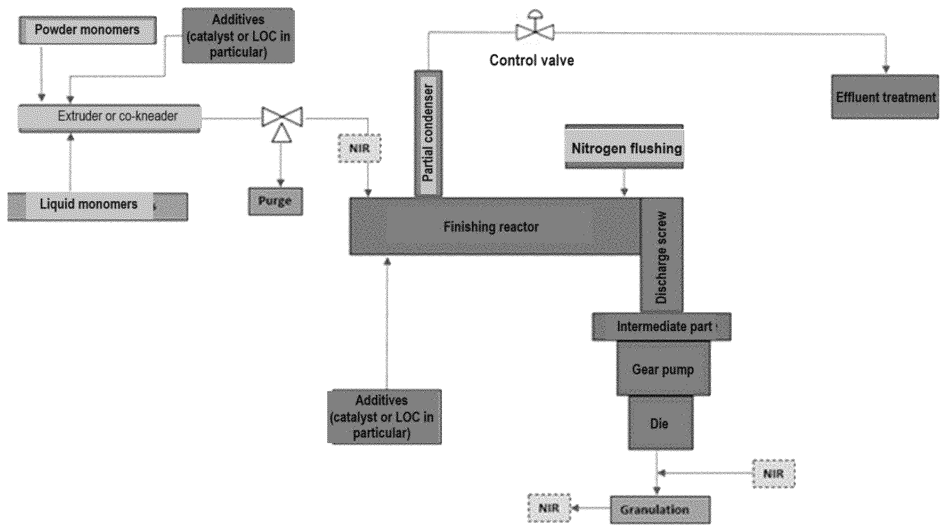

### DETAILED DESCRIPTION OF THE INVENTION

Other characteristics, aspects, objectives and advantages of the present invention will become more clearly apparent on reading the following description.

It is specified that the expressions “from . . . to . . . ” and “between . . . and . . . ” used in the present description are to be construed as including each of the indicated limits.

The method of the invention comprises at least the two aforementioned consecutive steps: steps a) and b). This method may comprise prior or subsequent steps of these two steps a) and b), but it does not comprise an intermediate step between steps a) and b).

The method of the invention can be applied in particular to aliphatic, cycloaliphatic, arylaliphatic, aromatic or semi-aromatic polyamides.

Step a)—Melting of a Mixture Comprising Polyamide Monomers

At step a), the mixture comprising monomers is brought to melt temperature in an extruder or co-kneader, said monomers being fed into the extruder or co-kneader without the addition of water.

In other words, the polyamide monomers fed into the extruder or co-kneader are not solubilised in water or more generally in a solvent.

Therefore, preferably, the mixture used at step a) has a very low water content, typically less than 2%, in particular less than 1% by weight of water relative to the total weight of the mixture.

Any water which may be present after step a) is essentially derived from possible onset of condensation of the monomers after melting thereof.

### Monomers

The polyamide monomers are monomers suitable for the formation of a polyamide. They can be aliphatic, cycloaliphatic, arylaliphatic or else aromatic. These monomers can be in the form of an anhydrous salt, or a base or free acid. Irrespective of their form, the monomers are introduced without addition of water or solvent into the extruder or co-kneader.

Possibly only one monomer is used including both a carboxylic acid function and an amine function i.e. a monomer of amino-acid type, or alternatively at least two monomers one carrying two amine functions and the other carrying two carboxylic acid functions or an equivalent monomer of carboxylic acid anhydride type, or it can be a monomer of C₃-C₆ lactam type, or a mixture of these different monomers.

By amino-acid monomer, it is meant a molecule comprising a hydrocarbon chain generally having 2 to 40 carbon atoms carrying an amine function and a carboxylic acid function.

Among amino-acid monomers, particular mention can be made of 6-amino-hexanoic acid, 5-aminopentanoic acid, 7-aminoheptanoic acid, 11-aminoundecanoic acid, or 12-aminododecanoic acid.

By diamine monomer, it is meant a molecule comprising a hydrocarbon chain generally having 2 to 40 carbon atoms, carrying two amine functions.

The diamine monomers can particularly be chosen from among 1,4-tetramethylene diamine, 1,5-pentanemethylene diamine, 1.6-hexamethylene diamine, octane-1-ethylene diamine, decanemethylene diamine, dodecamethylene diamine, m-xylylene diamine, p-xylylene diamine, bis-(4-aminophenyl)methane, bis-(4-aminocyclohexyl)methane, 2,2′-dimethyl-4,4′-methylenebis(cyclohexylamine), 1.3-bis(aminomethyl)cyclohexane, 1.4-bis(aminomethyl)cyclohexane, meta-phenylenediamine, paraphenylenediamine, 2,2,4 or 2,4,4-trimethylhexamethylene-diamine, or mixtures of these diamines.

The diamine monomers can preferably be chosen from among decanemethylene diamine, m-xylylene diamine, p-xylylene diamine, bis-(-4-aminocyclohexyl)methane, 2,2′-dimethyl-4,4′-methylenebis(cyclohexylamine), 1.3-bis(aminomethyl)cyclohexane, 1.4-bis(aminomethyl)cyclohexane, or mixtures of these diamines.

By dicarboxylic acid monomer, it is meant a molecule comprising a hydrocarbon chain and generally having 2 to 40 carbon atoms, carrying two carboxylic acid functions.

The dicarboxylic acid monomers able to be used are in particular succinic acid, glutaric acid, adipic acid, pimelic acid, suberic acid, azelaic acid, sebacic acid, undecanedioic acid, 1,12-dodecanedioic acid, dioleic acid, phthalic acid, terephthalic acid, isophthalic acid, 5-sulfoisophthalic acid, 1.4-cyclohexanedioic acid, 1,3-cclohexanedioic acid, or mixtures thereof.

The dicarboxylic acid monomers able to be used are preferably sebacic acid, 1.12-dodecanedioic acid, terephthalic acid, isophthalic acid, or mixtures thereof.

By C₃-C₆ lactam monomer, it is meant an amide included in a carbon ring having 3 to 6 carbon atoms. For example, caprolactam can be cited.

The mixture used at step a) may comprise one or more monomers chosen from among amino-acids, diacid/diacid monomer pairs, or a monomer of C₃-C₆ lactam type.

The monomers are preferably stored under an inert gas atmosphere, or under flushing of an inert gas, nitrogen in particular, before being input into the extruder of co-kneader, to prevent the entry of oxygen into the extruder or co-kneader and thereby reduce risks of oxidation of the monomers, or oligomers, prepolymers or polymers throughout the process. They can optionally have been previously subjected to a devolatilisation step.

The monomers can be fed into the extruder or co-kneader in different states. The monomers can be in the solid state or liquid state.

For example, the diamine monomer fed into the reactor can be in the liquid state, and the dicarboxylic acid monomer can be in the solid state.

No prior step to prepare a salt or prepolymer is necessary. The chosen monomer(s) can be directly fed into the extruder or co-kneader.

The monomers in the solid state are metered using dosing systems for solids, preferably gravimetric, generally with accuracy to within 1% relative to the set flow rate, preferably 0.5%, more preferably 0.1%.

They can be used under flushing of an inert gas, preferably nitrogen, preferably in anhydrous form.

They can be loaded into the extruder or co-kneader via a pneumatic loader, optionally with an inerting phase comprising at least one step using an inert gas, preferably nitrogen, preferably anhydrous.

Optionally, they can be previously inerted, in particular when stored in a vessel

The monomers in the solid state can be fed into the extruder or co-kneader via a single input, or different inputs.

It is also possible to use mixtures of monomers of same type, e.g. diacid or diamine, in solid form.

The monomers in liquid form can be metered using dosing system for liquids, generally with accuracy to within 1% relative to the set flow rate, preferably 0.5%, and more preferably 0.1%. Preferably, they are loaded using a positive displacement pump equipped with a mass flow meter.

They can be used under flushing of an inert gas, preferably nitrogen, preferably in anhydrous form.

Optionally, they can be previously inerted, in particular when stored in a vessel.

The monomers in liquid form can be fed via a single injection point or via different injection points.

It is particularly possible to inject several monomers in liquid form via a single injection point, optionally after a static mixer, or preferably via different injection points.

It is also possible to use mixtures of monomers of same type, e.g. diacid or diamine, in liquid form.

The monomers in the solid state and liquid state are preferably fed into the extruder or co-kneader via separate inputs.

The monomers in the solid state at ambient temperature can be loaded into the extruder or co-kneader after prior melting. In this case, they are heated to a temperature higher than the melt temperature thereof, in particular 5° C. higher and in particular 10° C. higher.

The monomers in liquid state at ambient temperature can be fed into the extruder or co-kneader at ambient temperature, or after heating.

### Extruder or Co-Kneader

The terms “extruder” or “co-kneader” are used in the present description in their usual meaning and designate equipment well known to skilled persons.

In particular, by “extruder” it is meant a device able to be use for extrusion i.e. a (thermo)mechanical process whereby compressed material is forced through a die, causing a change in the material. More particularly, an extruder is composed of at least one endless screw rotating in a cylinder called the body of the extruder, itself composed of several heat-regulating zones, and a liner in contact with the material. This endless screw ensures a seal between the screw and the wall along the entire length of the screw. In an extruder, each conveying screw is composed of different elements following after each other in the direction of travel. These different elements are positioned side by side on a rotating shaft. In a co-rotating extruder, all the conveying screws rotate in the same direction, which most often corresponds to clockwise direction as seen from the output of the extruder. The elements are positioned side by side on one same line. The different constituent conveying screws of an extruder all have one same diameter which generally remains constant along the length of the conveying screw. Most often, this diameter is in the range of 6 to 134 mm. In general, the elements positioned in one same plane, transverse to the direction of travel, are all identical.

The rotating speed of the conveying screws is dependent on the type of extruder, but is the same for all the constituent screws of the extruder. In general, the rotating speed of a screw is from 10 rpm to 1200 rpm according to extruder type.

Examples of extruders suitable for implementing the method of the invention are in particular those in the Evolum range by Clextral, the ZSK range by Coperion or STS range by Coperion.

The “co-kneaders” are also items of equipment well known to skilled persons. Unlike extruders, co-kneaders generally only have one endless screw which rotates and moves forward and back at the same time, and only have sealing between the screw and wall at certain specific points of the screw.

Examples of co-kneaders suitable for implementing the method of the invention are particular those in the SJW range by Xinda, or the MDK range by BUSS AG or COMPEO range by BUSS AG.

The diameter D of the screw of an extruder of co-kneader can vary according to the flow rate of raw materials. It is preferably greater than or equal to 40 mm, more preferably greater than or equal to 100 mm.

The ratio L/D, L designating the length of the screw in the extruder or co-kneader and D the diameter of the screw, is preferably higher than or equal to 30, preferably higher than or equal to 40.

The screw rotation speed can vary to a large extent according to flow rate and L/D ratio. It is preferably higher than or equal to 600 rpm, more preferably higher than or equal to 800 rpm, and better still higher than or equal to 1000 rpm.

Preferably, mixing is carried out in an extruder preferably comprising at least two screws, more preferably two screws, preferably co-rotating. These will allow efficient mixing of the reaction mixture comprising the monomers, and conveying thereof along the shaft of the screw(s) from the input to the output of the extruder, progressively passing through different temperature zones to obtain melting of the mixture of monomers.

The constituent elements of the screws are chosen to form sequences allowing either predominant conveying of material or predominant mixing of the fed monomer(s). Preferably, these sequences are chosen so that, downstream of the last input point of solid monomers, there is formed a continuously renewed vapour-proof plug of material.

The extruder or co-kneader comprises heating means such as electrical means or heat-exchange fluid, electrical means being preferred. These heating means are in addition to the mechanical energy that is transferred in the form of heat energy to the mixture at step a).

Melting of the mixture comprising the polyamide monomers is performed in the extruder or co-kneader by heating the mixture to an output temperature of step a) particularly of between 160° C. and 300° C., preferably between 20° and 280° C.

A temperature gradient along the shaft of the screw(s) is preferably applied between the input and output of the extruder of co-kneader.

Mixing can be conducted under flushing of an inert gas, preferably nitrogen, in particular in countercurrent-flow direction relative to the direction of travel of the reaction mixture in the extruder or co-kneader.

The mixture used at step a) may also comprise additives.

The additives can be chosen from conventional additives used in polyamides, well known to skilled persons.

For example, they can be chosen from among a catalyst, an antioxidant, heat stabilizer, UV absorber, light stabilizer, lubricant, inorganic filler, flame-retardant agent, nucleating agent, colourant, reinforcing fibres, wax, and mixtures thereof.

Advantageously, they are chosen from among a catalyst, stabilizer, antioxidant, chain-limiting agent, defoamer and/or mixture thereof.

In particular, the catalyst can be ortho-phosphoric acid, hypo-phosphorous acid or phosphorous acid. The stabilizer can be sodium hypophosphite, phosphite or a phenol. The chain-limiting agent can be acetic acid, stearic acid or benzoic acid. The defoamer can be a silicone oil.

The additives can be added to the extruder or co-kneader in liquid and/or solid form, in particular via one or several inputs. They can also be added in a mixture with one or more monomers, alone or in a mixture.

In another embodiment, all or some of the additives can be injected in liquid form into the mixer-reactor, the remainder being fed into the extruder. They are preferably injected into the first ⅖ths of the mixer-reactor, more preferably upstream of the 1^{st} orifice for evacuation of the gas phase.

Injection of Additives in Liquid Form into the Extruder

The additives in liquid form are added via one or more injection points, preferably using an injector

The liquid additives can be injected at ambient temperature, heated without being melted, or melted. They can also be added in the form of an aqueous solution.

Several additives in liquid form can be injected in liquid form at one injection point, optionally after previously being mixed in a static mixer. Preferably, they are injected via one or more injection points.

One or more additives, or part of the additive(s) in liquid form, can be added in a mixture with one or more liquid monomers, or part of the liquid monomer(s) at one or more feed points, optionally after previously being mixed in a static mixer.

These additives in liquid form can be used under flushing with inert gas, preferably nitrogen, preferably anhydrous, or under a headspace composed of inert gas, preferably nitrogen, preferably anhydrous.

Loading of Additives in Solid Form into the Extruder

The additives in solid form are fed into the extruder or co-kneader after metering by solid matter dosing equipment, preferably gravimetric.

They are added with accuracy to within 1% relative to the setpoint, preferably to within 0.5%, and more preferably 0.1%.

These additive(s) in solid form can be used under flushing by inert gas, preferably nitrogen, preferably anhydrous.

They can be loaded into the extruder or co-kneader via a pneumatic loader, optionally with an inerting phase comprising at least one step using an inert gas, preferably nitrogen, preferably anhydrous.

Optionally, they can be previously inerted, in particular when stored in a vessel.

All or some of the additives in solid form can previously be mixed with other additives or monomers in solid form, before being added to the extruder or co-kneader,

In one embodiment, all or some of additives can be mixed with other additives or monomers, preferably solid, for addition to the extruder or co-kneader.

In one embodiment, the additives can be previously mixed together, then added to the extruder or co-kneader via a single feed point.

In another embodiment, mixing can be carried out in the feed line, supplied by several vessels each containing an additive or mixture of additives, with one or more static mixers to form the mixture in the feed line.

In another embodiment, several additives are added to the extruder or co-kneader separately. In other words, each additive is added to the extruder or co-kneader via a separate feed point.

Between step a) and step b), it is possible to divert the flow of material leaving the extruder or co-kneader, before it enters the mixer-reactor, towards a purge during transitional phases of the method such as stoppage and start-up.

The extruder, at the output thereof, may therefore comprise a system of several valves, or preferably a three-way valve, preferably with minimum non-renewed volume.

Transfer of material from the extruder or co-kneader to the mixer-reactor can take place under gravity, or optionally by means of a gear pump.

The product obtained after step a) is a mixture of monomers in the molten state and forms a liquid phase.

As a function of mixing conditions and the monomers used, it is possible that the polycondensation reaction may already have been initiated at step a). In this event, the product resulting from step a) may comprise a prepolymer of very low molar mass. The inherent viscosity of the prepolymer in m-cresol, measured according to standard ISO 307:2019, is generally strictly lower than 0.40 dL/g, preferably lower than or equal to 0.30 dL/g, more preferably lower than or equal to 0.25 dL/g.

The product obtained after step a) may comprise a vapour phase essentially composed of water vapour. This is mostly derived from condensation water generated at the melting step when the onset of the polycondensation reaction has already started at this step.

Preferably, the extruder or co-kneader comprises less than two, more preferably no water evacuation device, in particular for water formed by the polycondensation reaction. Said devices are also called devolatilisation devices in the remainder hereof. This prevents the entraining, with evacuated water, of monomers that changed to vapour form under the melt conditions, and thereby allows the stoichiometry of the monomers to be maintained on leaving the extruder after step a), and hence in the mixture used at step b) for the polycondensation reaction in the mixer-reactor. In addition, this simplifies the method and improves product quality by eliminating management of the conveying of material towards the devolatilisation devices, this conveying being aggravated by the low viscosity of the product in the extruder. Finally, devolatilisation of water in the extruder would generate the need to transfer major quantities of energy towards the centre of the extruder, whereas the heating efficacy of extruders is low by design and in addition, since the melted product has low viscosity, the mechanical energy transmitted by the screws is very low.

Advantageously, the stoichiometry and/or conversion of the mixture of monomers can be controlled in the extruder. In particular, measurements of the chain ends of the product resulting from step a) can be performed directly on the liquid phase leaving the extruder or co-kneader, without isolation thereof and without a recirculation loop of material. Preferably, this measurement is performed by near-infrared spectrometry (NIR) using a measuring probe positioned in the flow of liquid phase. Depending on the measurement result, the input flow rates of the monomer into the extruder or co-kneader and/or the flow rates of additives can be adjusted, preferably automatically, to obtain the desired stoichiometry and/or conversion. Preferably, adjustment is made by modifying the flow rate(s) of the liquid monomer(s).

The residence time of the monomers in the extruder or co-kneader may vary as a function of flow rate, characteristics and/or operating parameters of the extruder or co-kneader. It is preferably less than or equal to 3 minutes, more preferably less than or equal to 2 minutes, and more preferably less than or equal to one minute.

Step b)—Polycondensation

The flow of material i.e. the product obtained after step a) is directly fed into the mixer-reactor, in particular without any interruption of the flow of material between the extruder or co-kneader and the mixer-reactor.

In particular, the mixture obtained at step a) is fed into the mixer-reactor at step b) without prior devolatilisation.

The monomers in the molten state and mixed in the extruder or co-kneader continue to react in the mixer-reactor.

The mixer-reactor used at step b) is a reactor conventionally used for the synthesis of polyamides, in particular as reactor-finisher i.e. to conduct the finishing step of the polyamides. Examples of mixer-reactors able to be used in the invention are particularly described in applications EP1436073, U.S. Pat. No. 8,376,607 and EP0715882.

More particularly, the mixer-reactor is typically a reactor with horizontal shaft. It is generally a horizontal cylindrical reactor or horizontal reactor with oval cross-section.

The length and diameter of the reactor of the reactor are chosen, and the flow rate of the reaction mixture in the molten state i.e. the liquid can be adapted and controlled to adjust the residence time in the reactor and thereby obtain the desired rate of progress.

The length of the mixer-reactor can be in the region of three times the inner diameter of the reactor.

The mixer-reactor is partially filled with the liquid phase. In general, the proportion of mixer-reactor filling by the liquid phase is between 20 and 75% of the initially available space within the reactor, in particular to promote renewal of the interface between the liquid phase and gas phase, and therefore the removal of water formed throughout polycondensation.

The mixer-reactor comprises one or more agitators. The agitator is mounted horizontally so that it can rotate inside the reactor. For example, it can be an Archimedes screw, an agitator of cage type, or successive discs whether or not with openwork, mounted on a shaft. The diameter of the agitator is generally slightly smaller than the inner diameter of the reactor-mixer. The shaft of the agitator can be offset from the shaft of the finishing reactor. This particularly allows circulation of the gas phase within the reactor. This circulation can also be ensured by holes formed in the discs of the agitator for example. If several agitators are used, the structure of the agitators can differ from each other.

The rotation speed of the agitator can be between 5 and 100 rpm for example.

The agitator may comprise several discs defining compartments in the mixer-reactor. For example, the agitator may comprise between 5 and 15 discs. The last compartment of the mixer-reactor corresponds to the space lying between the last disc on the shaft and the vertical end wall of the mixer-reactor.

The mixer-reactor is preferably self-cleaning. More particularly, it is a reactor comprising two shafts, preferably co-rotating. In particular it can be a mixer-reactor of REACOM type marketed by BUSS-SMS-CANZLER, or of LIST CRP/TCP type marketed by LIST TECHNOLOGY AG.

Step b) is conducted at a temperature higher than the solidification temperature of the prepared polyamide, preferably at a temperature more than 5° C. higher than this solidification temperature, more preferably at a temperature more than 10° C. higher than this solidification temperature.

The heating temperature of the polycondensation reactor can be adjusted according to the intrinsic polycondensation kinetics of the product to be synthesised.

The polycondensation reaction can in particular be performed at a temperature of between 240° C. and 310° C., at a pressure close to atmospheric pressure.

Heating is obtained by heating the walls of the barrels of the mixer-reactor, and also preferably the rotating shaft(s) thereof. Preferably heating of the mixer-reactor is obtained with a heat-exchange fluid. Preferably, the rotating shaft(s) are heated to a temperature higher than or equal to the temperature of the barrel walls of the mixer-reactor.

The residence time of the molten material in the mixer-reactor is longer than or equal to 5 minutes, preferably longer than or equal to 10 minutes, more particularly longer than or equal to 15 minutes. Preferably, the residence time is less than or equal to 60 minutes, preferably less than or equal to 50 minutes, and more particularly less than or equal to 40 minutes.

The level of liquid phase in the reactor derived from the product obtained at step a) is preferably 20% greater than the initial free volume in the reactor, more preferably 25% greater and further preferably 35% greater.

The level of liquid phase in the reactor is preferably less than 75%, more preferably less than 65%, further preferably less than 55%.

The level of liquid phase in the mixer-reactor can be monitored by visual evaluation and/or direct weighing of the reactor and/or measured by a level probe and/or by gravimetric monitoring of reactor input/outputs (mass balance).

The condensation water chiefly produced in the mixer-reactor, but also possibly at the melting step a), is advantageously removed by means of a flow of inert gas, preferably in countercurrent-flow.

Preferably, the injection of inert gas, preferably nitrogen, is performed at one or more feed points. The inert gas can be injected in the gas phase or liquid phase of the mixer-reactor, preferably in the gas phase. Preferably, the internal flow of gas takes place in opposite parallel direction to the flow of liquid reaction mixture. In this case, the inert gas is preferably injected into the last ⅘ths of the length of the reactor, more preferably the second to last compartment of the mixer-reactor, more advantageously into the last compartment of the mixer-reactor. The inert gas can be heated before being injected into the mixer-reactor. The humidity content of the inert gas can be modulated before being injected into the mixer-reactor.

The mixer-reactor comprises one or more orifices for evacuation of the gas phase from the mixer-reactor, preferably upstream of the inert gas feed point relative to the direction of flow of the reaction liquid. In this case, the orifice(s) to evacuate the gas phase are preferably positioned within the first ⅖ths of the reactor, more preferably between the 2^{nd} and 3^{rd} compartments of the reactor.

The flow rate of inert gas, nitrogen in particular, fed into the reactor is defined to obtain a water vapour dilution factor F of less than 1.40, preferably less than 1.20, more preferably less than 1.10.

$$\frac{inert gas flow rate + water vapour flow rate}{water vapour flow rate} = F$$

The gas phase is generally composed of the inert gas, condensation water and residual volatile compounds from polycondensation, in particular chosen from among additives, oligomers of molar mass lower than 1000 g/mol, amino-acids, diamines, cyclic compounds, alone or in a mixture.

In particular, for polyamide compositions only comprising monomers of amino-acid type, the compounds are composed of a mixture of oligomers, amino-acids, cyclic dimers and additives.

The reactor-mixture can be equipped with a device managing the gas phase at the output of the polycondensation reactor, preferably at a pressure close to atmospheric pressure, called a devolatilisation line.

Preferably, the mixer-reactor comprises a gas phase evacuation orifice connected to the devolatilisation line, at a pressure close to atmospheric pressure.

Advantageously, the devolatilisation line comprises a device called a control valve which allows adjustment of the pressure in the mixer-reactor to a value close to that of atmospheric pressure.

Advantageously, the devolatilising line is at a temperature higher than the softening temperature of the oligomers, preferably higher than the melt temperature of the oligomers.

The temperature of the devolatilising line is between 12° and 300° C., preferably between 18° and 300° C., more preferably of 180 to 250° C.

Preferably, the mixer-reactor comprises at least two devolatilising devices, preferably the same, both connected to the reactor by the same orifice, with only one operating at a time, so that they can be cleaned without interrupting the process by switching from one to the other.

The water vapour and other volatile compounds such as the monomers or oligomers, which are therefore removed, can be separated by conventional distillation systems. The monomer(s) and/or oligomer(s) recovered at this separation can be cycled back to the extruder, alone or in a mixture with other non-recycled monomers.

For the synthesis of polyamide comprising one or more diamines, the gas phase leaving the mixer-reactor may particularly comprise one or more of these diamines.

Preferably, a partial condenser is positioned between the gas phase evacuation orifice of the mixer-reactor and the devolatilising line to separate the diamine or mixture of diamines, contained in the gas phase, from the other compounds. The mass flow rate of diamine, alone or in a mixture with other diamines, exiting the partial condenser is less than or equal to 10% compared with the total mass flow of diamine fed at step a), preferably less than or equal to 5%, more preferably less than or equal to 3%, advantageously less than or equal to 1%.

The recovered diamine or mixture of diamines can then be directed towards a vessel, and optionally undergo subsequent treatment to modify the composition thereof, for example in a rectifying column, for reuse as monomer at the input of step a), preferably in a mixture with the non-recycled diamine or diamine mixture.

It is also possible to recycle the recovered diamine or diamine mixture back to the mixer-reactor without additional treatment, preferably in the first 2/8ths of the reactor, more preferably in the first ⅛^{th} of the mixer-reactor, more advantageously at the same level of the reactor screws as that used to feed the product derived from step a).

The set temperature of the partial condenser is between 90° C. and 200° C., preferably between 95° C. and 200° C., more preferably between 100° C. and 150° C., more advantageously between 100° C. and 120° C.

Advantageously, a demister or bed droplet separator is inserted between the gas phase evacuation orifice of the mixer-reactor and the partial condenser.

The gas phase passing through the devolatilising line can then be cooled at the end of the line where all or some of the constituents thereof can be changed from gas state to liquid state and/or solid state. This operation can be performed in a condenser having a temperature lower than the condensation temperature of the most volatile compound contained in the gas phase. Preferably, scrubbing of the gas phase is carried out with a solvent, preferably water. For this purpose, it is possible to use one or more devices connected in series such as spray columns, cyclonic spray scrubbers, packed bed scrubbers, plate scrubbers, whether in co-flow, counterflow or crossflow.

The phase(s) obtained can be subsequently treated to separate solubilised or dispersed compounds in colloid form in the solvent and/or to separate the solids from the solvent. Several methods are known to skilled persons such as coagulation, flocculation, electrocoagulation precipitation, adsorption, ion-exchange, decanting, centrifugation, filtration, flotation.

The product can be extracted from the mixer-reactor by a vertical discharge single or twin-screw through a discharge port formed in the barrels of the mixer-reactor. The discharge port can be positioned on one of the walls of the mixer-reactor at the downstream end thereof, or on the vertical end wall of the mixer-reactor.

The discharge screw(s) can be heated, advantageously to a temperature higher than or equal to the temperature of the barrels of the reactor mixer. If twin screws are used, these can have straight or conical geometry and can be positioned in relation to the reactor discharge port one behind the other, or the same level as each other.

The product can then be taken in charge by a gear pump allowing regulated output from the reactor. Downstream of this gear pump, a heated die can be positioned allowing granules to be obtained either by direct cutting or advantageously via granulation of rods obtained by cooling the product in a tank of water.

Optionally, the granules are dried in-line by an airstream parallel to the rods and flowing in opposite direction to the direction of travel of the rods.

Measurement of stoichiometry and/or conversion of the product resulting from step b) can be carried out. In particular, the chain ends of the product resulting from step b) can be measured directly on the liquid phase leaving the mixer-reactor, without isolation thereof and without a material recirculation loop. Preferably, this measurement is performed by near-infrared spectrometry (NIR) using a measuring probe positioned in the flow of liquid phase.

It is also possible to perform this measurement on solid granules leaving the mixer-reactor. Preferably this measurement is performed by near-infrared spectrometry (NIR).

According to measurement results, the flow rates of monomers and/or flow rates of additives can be adjusted at the input to the extruder or co-kneader and/or in the mixer-reactor preferably at the first 2/8^{ths} thereof, more preferably at the first ⅛^{th} of the mixer-reactor, and more advantageously at the same level of the screws of the mixer-reactor as the feed point of the product derived from step a), preferably automatically to obtain the desired stoichiometry and/or conversion. Preferably, adjustment is obtained by modifying the flow rate(s) of the liquid monomer(s).

According to measurement results, the flow rate and/or humidity content of the inert gas flow in the mixer-reactor can also be adjusted, preferably automatically, to obtain the desired conversion.

Advantageously, the polyamide obtained with the method of the invention after step b), has an inherent viscosity in solution in meta-cresol, measured according to standard ISO 307:2019, of at least 0.80 dL/g, preferably at least 1.10 dL/g, more preferably at least 1.30 dL/g.

Advantageously, the polyamide obtained with the method of the invention after step b), has inherent viscosity in solution in meta-cresol, measured according to standard ISO 307:2019, of at most 2.50 dL/g, more preferably of at most 2.20 dL/g, further preferably of at most 1.80 dL/g.

### Examples

In the following examples, the following abbreviations are used:
A11 corresponds to 11-amino-undecanoic acid;
DA10 corresponds to decanediamine;
B corresponds to bis-(3-methyl-4-aminocyclohexyl)-methane (or 3,3′-dimethyl-4,4′-diamino-dicyclohexyl-methane) also called BMACM or MACM;
T corresponds to terephthalic acid;
BAC corresponds to 1,3-bis(aminomethyl)cyclohexane. It has a cis isomer content of 75%.

A co-rotating twin-screw extruder ZSK30 (diameter of 30 millimetres and length of 38 Diameter) manufactured by Werner & Pfleiderer equipped with 2 gravimetric metering feeders positioned at the start of the feed zone, and provided with 2 injection points on barrels 4 and 6. The heating of this extruder was obtained via electrical heating elements under the conditions given in Table 2. No devolatilising sink was provided.

The output of the extruder was connected via a tube, heated by a heat-exchange fluid, to a self-cleaning mixer-reactor LIST TCP4 CONTI marketed by LIST TECHNOLOGY AG, having a free volume of 7.4 litres. Transfer of the product between the output of the extruder and the input of the mixer-reactor was performed under gravity.

The mixer-reactor was equipped with two co-rotating agitators forming 11 chambers, and the walls and two agitator shafts thereof were heated to the same temperature by heat-exchange fluid. Feeding of the product into the reactor-mixer was at the first compartment. Extraction of the product from the reactor-mixer was ensured by two vertical discharge screws through a discharge port positioned on the vertical end wall of the mixer-reactor. A gear pump positioned downstream of these discharge screws allowed adjustment of output flow and conveying of the product through a heated die. The rod obtained was cooled in a tank of water and granulated.

A flow of nitrogen was fed into the gas phase of the reactor into the nineth compartment, in countercurrent flow. The gas phase of the reactor was evacuated at the fourth compartment. The gas phase first passed through a partial condenser heated by heat-exchange fluid, the condensates being directed into the reactor at the fourth compartment, after which the gas phase entered an electrically heated downstream devolatilisation line. A total condenser heated by heat-exchange fluid was positioned at the end of this devolatilisation line.

Melting of the monomers and loading of the different additives were performed in the extruder. The monomers corresponded to compositions PA11 (polymer A), PA 11/10T (polymer B), PA 11/B10 (polymer C), and PA BACT/10T (polymer D).

The diacids were charged in solid form in the feed hopper and the mass flows thereof metered by gravimetric feeders.

The diamines were heated to 80° C. in a vessel then injected into barrel 6 by means of a positive displacement pump servo-controlled by a mass flow meter to control the mass flows thereof. For polymer D, the two diamines 1,3-1

BC and DA10 were previously mixed in the vessel before being injected into barrel 6 at a single injection point.

The additives in liquid form were fed into the extruder at barrel 4 by injection and/or into the mixer-reactor at the first compartment. The additives in solid form were added in the form of a dry blend with one of the monomers. The feed conditions are described in Table 1. In Example 5, a mixture of two additives was injected into the extruder at a single injection point of barrel 4.

TABLE 1

| | | Acetic acid | | NaH2PO2 | H3PO4 | H3PO2 |
|---|---|---|---|---|---|---|
| | Stearic | 80 wt. % | Benzoic | 60 wt. % | 85 wt. % | 50 wt. % |
| | acid | solution | acid | solution | solution | solution |
| Form | Solid | Liquid | Solid | Liquid | Liquid | Liquid |
| Feed | Dry-blend | Injection | Dry-blend | Injection | Injection | Injection |
| | Extruder | Extruder | Extruder | Extruder | Mixer- | Mixer- |
| | | | | | reactor | reactor |

TABLE 2

| | Extruder | | | | | | | |
|---|---|---|---|---|---|---|---|---|
| | screw | | Barrel 2 | Barrel 4 | Barrel 6 | Barrel 8 | Barel 10 | |
| | speed | Barrel 1 | Barrel 3 | Barrel 5 | Barrel 7 | Barrel 9 | Barrel 11 | Barrel 12 |
| | rpm | ° C. | ° C. | ° C. | ° C. | ° C. | ° C. | ° C. |
| POLYMER | 340 | 30 | 100 | 190 | 190 | 190 | 190 | 190 |
| A | | | | | | | | |
| POLYMER | 280 | 30 | 50 | 150 | 200 | 250 | 250 | 250 |
| B | | | | | | | | |
| POLYMER | 340 | 30 | 50 | 150 | 200 | 250 | 250 | 250 |
| C | | | | | | | | |
| POLYMER | 280 | 30 | 50 | 150 | 200 | 250 | 250 | 250 |
| D | | | | | | | | |

TABLE 3

| | Unit | Ex. 1 | Ex. 2 | Ex. 3 | Ex. 4 | Ex.5 |
|---|---|---|---|---|---|---|
| Solidification point | ° C. | 190 | 190 | 260 | 260 | 260 |
| A11 | kg/h | 11 | 11 | 2.88 | 2.94 | 2.71 |
| DA10 | kg/h | — | — | 3.89 | 4.03 | 3.6 |
| AT | kg/h | — | — | 3.41 | 3.48 | 3.21 |
| DC10 | kg/h | — | — | — | — | — |
| 1,3-BAC | kg/h | — | — | — | — | — |
| BMACM | kg/h | — | — | — | — | — |
| Total monomer flow rate | kg/h | 11 | 11 | 10.8 | 10.45 | 9.52 |
| Stearic acid | g/h | — | — | 185 | — | — |
| Acetic acid 80 wt. % solution | g/h | — | — | — | 100 | 90 |
| Benzoic acid | g/h | — | — | — | — | — |
| NaH2PO2 60 wt. % solution | g/h | — | — | — | 50 | 50 |
| H3PO4 85 wt. % solution | g/h | 20 | 20 | — | — | — |
| H3PO2 50 wt. % solution | g/h | — | — | — | — | — |
| Level | % | 42 | 42 | 45 | 45 | 42 |
| Residence time | minutes | 15 | 15 | 17 | 17 | 17 |
| Reactor agitator speed | rpm | 60 | 60 | 60 | 60 | 60 |
| T ° C. reactor | ° C. | 250 | 250 | 300 | 300 | 300 |
| T ° C. partial condenser | ° C. | 230 | 230 | 110 | 140 | 180 |
| T ° C. devolatilising line | ° C. | 230 | 230 | 180 | 180 | 180 |
| T ° C. total condenser | ° C. | 80 | 80 | 80 | 80 | 80 |
| Mixer-reactor nitrogen flow | L/h | 5 | 30 | 50 | 50 | 50 |
| rate | | | | | | |
| Dilution factor | — | 1.00 | 1.02 | 1.04 | 1.04 | 1.04 |
| Diamine losses | % | — | — | 7.3 | 8.6 | 9.5 |
| Viscosity in solution | dL/g | 1.44 | 1.65 | 1.22 | 1.22 | 1.13 |
| Mixer-reactor output | | | | | | |
| Viscosity in solution | dL/g | 0.15 | 0.15 | 0.10 | 0.10 | 0.10 |
| Extruder output | | | | | | |
| | Unit | Ex. 6 | Ex. 7 | Ex. 8 | Ex. 9 | Ex.10 |
| Solidification point | ° C. | 260 | 260 | 150 | 150 | 275 |
| A11 | kg/h | 2.94 | 2.94 | 0.98 | 0.98 | — |
| DA10 | kg/h | 3.97 | 3.97 | — | — | 2.81 |
| AT | kg/h | 3.48 | 3.48 | — | — | 4.42 |
| DC10 | kg/h | — | — | 3.98 | 3.98 | — |
| 1,3-BAC | kg/h | — | — | — | — | 1.79 |
| BMACM | kg/h | — | — | 4.84 | 4.84 | — |
| Total monomer flow rate | kg/h | 10.39 | 10.39 | 9.80 | 9.80 | 9.02 |
| Stearic acid | g/h | 185 | 185 | — | — | — |
| Acetic acid 80 wt. % solution | g/h | — | — | 14 | 14 | — |
| Benzoic acid | g/h | — | — | — | — | 95 |
| NaH2PO2 60 wt. % solution | g/h | 50 | 50 | — | — | 43 |
| H3PO4 85 wt. % solution | g/h | — | — | — | — | — |
| H3PO2 50 wt. % solution | g/h | — | — | 8 | 8 | — |
| Level | % | 45 | 45 | 45 | 45 | 45 |
| Residence time | minutes | 17 | 17 | 18 | 18 | 20 |
| Reactor agitator speed | rpm | 60 | 60 | 60 | 60 | 60 |
| T ° C. reactor | ° C. | 300 | 300 | 280 | 280 | 300 |
| T ° C. partial condenser | ° C. | 110 | 110 | 110 | 110 | 110 |
| T ° C. devolatilising line | ° C. | 180 | 180 | 180 | 180 | 180 |
| T ° C. total condenser | ° C. | 80 | 80 | 80 | 80 | 80 |
| Mixer-reactor nitrogen flow | L/h | 120 | 200 | 50 | 200 | 50 |
| rate | | | | | | |
| Dilution factor | — | 1.09 | 12.14 | 1.05 | 1.19 | 1.04 |
| Diamine losses | % | 7.6 | 8.2 | 2.5 | 2.6 | 7.5 |
| Viscosity in solution | dL/g | 1.41 | 1.59 | 1.02 | 1.21 | 0.90 |
| Mixer-reactor output | | | | | | |
| Viscosity in solution | dL/g | 0.10 | 0.10 | 0.10 | 0.10 | 0.10 |
| Extruder output | | | | | | |

In Tables 1 to 3 above, the terms used have the following meanings:
“wt. %” indicates weight percentage;
“Level” refers to the proportion of free volume of the mixer-reactor occupied by the mixture obtained after step a) and fed into the mixer-reactor;
“Residence time” refers to the residence time in the mixer-reactor;
“Dilution factor”: the flow rate of inert gas, nitrogen in particular, fed into the reactor is defined to obtain a water vapour dilution factor F lower than 1.40, preferably lower than 1.20, more preferably lower than 1.10.

$$\frac{inert gas flow rate + water vapour flow rate}{water vapour flow rate} = F$$

“Diamine losses” refers to the weight of total diamine monomers recovered at the output of the total condenser equipping the devolatilisation line, relative to the total weight of diamine monomers fed into the extruder.

1. A continuous method for preparing polyamide by condensation comprising the following consecutive steps:
a) melting a mixture comprising polyamide monomers in an extruder or co-kneader, the monomers being delivered to the extruder or co-kneader without the addition of water, and
b) carrying out a polycondensation reaction of the mixture obtained after step a) in a horizontal mixer-reactor,
steps a) and b) of the method being carried out at a pressure close to atmospheric pressure.

2. The method according to claim 1, wherein the polyamide prepared according to the method is an aliphatic, cycloaliphatic, arylaliphatic, aromatic or semi-aromatic polyamide.

3. The method according to claim 1, wherein the polyamide is particularly chosen from among polyamide 11, 11/B10, 11/BI/BT, B10, B12, MXD10, MXD.6, 11/10T, 11/BACT/10T, BACT/10T.

4. The method according to claim 1, wherein the mixture at step a) comprises additives.

5. The method according to claim 4, wherein the additives comprise at least one catalyst, at least one stabiliser, at least one antioxidant, at least one chain-limiting agent and at least one defoamer.

6. The method according to claim 1, wherein step a) is performed in an extruder, preferably having at least two screws, preferably two screws, in particular co-rotating.

7. The method according to claim 1, wherein melting of the mixture of monomers is performed in the extruder or co-kneader by heating the mixture to an output temperature of step a) of between 160° C. and 300° C.

8. The method according to claim 1, wherein the mixture obtained after step a) is fed into the mixer-reactor at step b) without prior devolatilisation.

9. The method according to claim 1, wherein the mixer-reactor comprises at least two shafts comprising agitation elements.

10. The method according to claim 1, wherein the agitation shafts of the mixer-reactor are heated.

11. The method according to claim 1, wherein the polycondensation reaction at step b) is conducted at a temperature that is at most 50° C. higher than the solidification temperature of the polyamide.

12. The method according to claim 1, wherein step b) is performed under inert gas flushing, preferably in countercurrent-flow.

13. A system for implementing the method of claim 1, comprising an extruder or co-kneader directly connected to the input of a mixer-reactor, in particular without an intermediate devolatilising device between the mixer-reactor and the extruder or co-kneader.
